(19) United States
(12) Patent Application Publication
(10) Pub. No.: US 2023/0075123 A1
(43) Pub. Date: Mar. 9, 2023

(54) BATTERY ARRANGEMENT AND METHOD OF PROVIDING A BATTERY ARRANGEMENT

(71) Applicant: AUDI AG, Ingolstadt (DE)

(72) Inventor: Eduard MAIN, Buxheim (DE)

(73) Assignee: AUDI AG, Ingolstadt (DE)

(21) Appl. No.: 17/893,485

(22) Filed: Aug. 23, 2022

(30) Foreign Application Priority Data
Sep. 9, 2021 (DE) 102021123312.7

(51) Int. Cl. H01M 50/209; H01M 50/249; H01M 50/26; H01M 10/0525

(52) U.S. Cl. CPC H01M 50/209; H01M 50/249; H01M 50/26; H01M 10/0525; H01M 2220/20

(57) ABSTRACT

A battery arrangement for a motor vehicle, with a first battery module including at least one first battery cell and a second battery module including at least one second battery cell. Here, the first battery module has a first module housing with a first interior space in which the at least one first battery cell is arranged, and the second battery module has a second module housing with a second interior space in which the at least one second battery cell is arranged. The first and second interior spaces are designed to be sealed with respect to one another.

### FIELD

A battery arrangement for a motor vehicle, which has a first battery module comprising at least one first battery cell and a second battery module comprising at least one second battery cell. Furthermore, the invention also relates to a method for providing a battery arrangement.

### BACKGROUND

Battery arrangements for motor vehicles can, for example, be designed as high-voltage batteries. These typically comprise many individual battery cells. These can in turn be combined into cell stacks or cell bars or cell modules. Such a cell module, which is also referred to as a battery module, thus comprises at least one battery cell, but preferably several cells, which can be, for example, lined up or stacked. The battery module may also be held together by separate components surrounding the battery module. Such battery modules are further arranged and mounted in an overall battery housing.

If a battery cell becomes defective, for example in the course of a motor vehicle accident, a so-called thermal runaway of a cell can occur. It is also possible to trigger a thermal runaway by an internal short shot. In addition, contamination of the cell during the manufacturing process can also lead to a thermal runaway later on in the event of a quality defect. This results in the development of heat and pressure in the cell. Once a certain pressure threshold is exceeded, a safety valve in the cell opens and allows the cell to equalize pressure. In this process, the hot gas formed in the cell flows into the battery space together with the electrically conductive components of the cell, such as cathode material, anode material and electrolyte, and distributes itself in the battery space. As a result of thermal runaway, thermal propagation usually occurs at the cell module level. This means that other cells of the cell module or battery also go through thermally. This releases even more hot gas and electrically conductive precipitate in the battery. This in turn heats up other cells and cell modules in the battery and contaminates them with conductive ejecta. Rising temperatures in the battery cause more cells to thermal runaway and cell modules to propagate. The electrically conductive precipitate minimizes clearances and creepage distances and/or creates short circuits. Both lead to the formation of electric arcs and thus to the fire of the battery. This constellation requires massive concepts on battery level and enormously complicates the controllability of such incidents.

In this context, WO 2015/031761 A1 describes an energy storage device that can have a battery housing and a plurality of battery modules arranged in the battery housing. A respective battery module may in turn comprise several battery cells. Several layers can be arranged between the battery modules to prevent thermal propagation between the cell modules. These layers include an elastic layer and at least one thermal insulating layer, which may include a ceramic. In the event of a thermal event of one of the battery modules, the gas escaping from the battery module is reflected by these layers and thus shielded from the neighboring battery module located in the same housing. Holes may also be provided in the layers to allow pressure equalization between the battery modules. In addition, the housing can be designed to be oxygen-free and airtight on the inside. This is to prevent a fire inside the housing.

An oxygen-free design of a housing interior is relatively complex or even impossible to implement, since the battery should be able to equalize pressure with the environment in the event of temperature fluctuations. The thermally insulating layer structure to inhibit thermal propagation of the battery modules is also complex to manufacture and very costly to implement. Especially for applications in the field of high-voltage batteries for motor vehicles, these measures do not seem practicable.

### SUMMARY

It is therefore an object of the present invention to provide a battery arrangement and method that enable thermal propagation of battery modules to be inhibited in the most efficient and simple manner.

A battery arrangement for a motor vehicle according to the invention has a first battery module comprising at least one first battery cell and a second battery module comprising at least one second battery cell. The first battery module has a first module housing with a first interior space in which the first battery cell is arranged, and the second battery module has a second module housing with a second interior space in which the at least one second battery cell is arranged, wherein the first and second interior spaces are designed to be sealed off from one another.

The fact that the first and second interior spaces are sealed off from one another, in particular sealed off with regard to air exchange, means that gas exchange between the first and second interior spaces is at least significantly more difficult or not possible at all. In this regard, the invention is based on the realization that the main reason for thermal propagation among battery modules within a battery enclosure is that gas exchange is possible between the arrangement regions of the battery modules. If thermal runaway occurs in a cell of a battery module, or even in several cells of a battery module, the corresponding cells outgas, which not only causes extremely hot gas to escape from the cells, but this outgassing also leads to an enormous increase in pressure within the arrangement region of the relevant, thermally runaway battery module. Even when thermal insulators are arranged between the battery modules, even small gaps or openings, which, for example, allow pressure equalization between the arrangement chambers, enable these hot gases to pass very quickly from one arrangement region to the next arrangement region of the adjacently arranged battery module due to the very high pressure. It has been shown that sealing the accommodation areas in which the individual battery modules of the battery arrangement are accommodated, and which are referred to herein as the first and second interior spaces, has a significantly more efficient effect on preventing thermal propagation than, for example, thermal insulation which nevertheless allows gas exchange between the arrangement regions. As a result of the fact that the first and second interior spaces are advantageously sealed off from one another, the gas escaping from a battery cell of one of the two battery modules is at least largely prevented from entering the other of the two interior spaces in which the other of the two battery modules is arranged. This at least temporarily protects the other of the two battery modules, and thermal runaway of this other still intact battery module can be prevented or at least significantly delayed. Sealing the two internal spaces against each other also eliminates the need for further thermal insulation measures between the battery modules and/or the module housings, which significantly simplifies the overall design of the battery arrangement, and significantly reduces manufacturing costs. For implementation, the battery modules can, for example, be arranged in individual chambers that are sealed against each other and provide the respective module housings. The one-piece chamber walls can be the only layer between and spatially separating the modules or their battery cells. The individual chambers can be provided in a particularly simple and cost-effective manner, as can their sealed design. The individual battery modules are thus spatially isolated and separated from each other, which makes thermal propagation much more difficult in a simple way. The respective interior spaces do not have to be oxygen-free, airless or similar. In particular, the sealed interior spaces may further be air-filled sealed interior spaces. Even if a fire occurs within one interior space, the mutual sealing of the interior spaces against each other also efficiently prevents the fire from spreading to the other of the two interior spaces. In this context, the respective interior spaces can optionally be designed with a certain negative pressure relative to an ambient pressure, although this need not necessarily be the case. By sealing the interior spaces from one another, the individual battery modules can be separated from one another, thus avoiding incidents of thermal propagation and, above all, reducing the need for costly measures at the battery level. Thus, a buildup of a reaction and propagation is limited to only one battery module. As soon as all cells of the affected battery module are propagated, the reaction consequently comes to a standstill, since it is not possible to spread to an adjacent battery module. The controllability of a thermal runaway is thus significantly improved.

The first and second battery modules can basically be of the same design, and are therefore referred to in the following in part simply as battery modules. The statements made about a battery module thus apply in the same way to both the first battery module and the second battery module or any optionally further battery module in the same way. Nevertheless, the battery modules may also differ from each other, for example, in terms of the number of battery cells they include, the type of battery cells they include, and/or the size of the battery cells they include, or the like. Generally, a battery module comprises at least one battery cell, but preferably more than one battery cell, that is, preferably multiple battery cells. The at least one battery cell can, for example, be a lithium-ion cell. In principle, such a battery cell can have any geometry, and be designed, for example, as a round cell, pouch cell, or prismatic battery cell.

Further, the battery arrangement may have more than just two battery modules, for example, three, four, five, and so on. Preferably, the battery arrangement is designed as a high-voltage battery for a motor vehicle. The invention offers particularly great advantages for high-voltage applications. If more than two battery modules are provided, a separate module housing is also provided for each additional battery module. The respective module housings do not have to be designed and arranged separately from each other, but can also be provided by a common battery housing in the form of individual chambers within such a common battery housing, as will be explained in more detail below. The module housings are also preferably made of a material that is as temperature-resistant as possible. Preferably, a respective module housing is made of a metallic material, such as steel. Steel is particularly temperature-stable and cost-effective. In principle, however, other materials are also possible, for example high-temperature plastics. Preferably, a material is used that is temperature-stable up to at least 500° C. or at least 600° C., i.e. has a melting point above at least 500° C. or 600° C., respectively. Individual components of the module housings can also be made of different such temperature-stable materials. For example, a module housing lower part can be made of aluminum and a housing cover can be made of steel.

The fact that the first and second interior spaces are sealed off from one another does not necessarily imply that the respective interior spaces must also be sealed off from the rest of the environment. In other words, the first interior space may be formed sealed from the second interior space, for example, so that at least no direct gas exchange from the first interior space to the second interior space is possible, but gas exchange may be possible between the first interior space and an environment of the first interior space that is different from the second interior space. Preferably, however, the interior spaces in question are also designed to be sealed off from a remaining environment. The sealed design with respect to the rest of the environment may be limited to a certain maximum pressure within the interior space in question. If this maximum pressure is exceeded, for example, a degassing opening of the relevant module housing can allow pressure equalization with the rest of the environment. Such a degassing opening may be provided, for example, by a pressure relief valve, a bursting diaphragm, or the like. In this regard, a respective such module housing may include such a releasable degassing opening that, when a certain internal pressure within the respective interior spaces is exceeded, allows the pressure of the respective interior space to equalize with an environment of the respective interior space that is different from the other interior spaces.

The fact that the first interior space is designed to be sealed off from the second interior space can, for example, be understood to mean that, in the event of gas escaping from the at least one first battery cell, only a predetermined proportion of this gas, which is smaller than a predetermined limit value, can penetrate into the second interior space. This limit value can be defined, for example, as less than 5 percent by weight, preferably less than 1 percent by weight based on the total amount of gas exiting the at least one first battery cell. The same applies to sealing the second interior space from the first and any other optional interior space. To accomplish this, various high-temperature gaskets, explained in more detail later, or simply a welded joint between a module housing lower part and a module housing cover can be considered.

In another advantageous embodiment of the invention, the first module housing comprises a first module housing lower part and a first module cover that is placed on the first module housing lower part and sealed with respect to the first module housing lower part, and wherein the second module housing comprises a second module housing lower part and a second module cover that is placed on the second module housing lower part and sealed with respect to the second module housing lower part. In this way, sealing of the first interior space against the second interior space and vice versa can be provided in a particularly simple and cost-efficient manner The respective module housings can therefore be designed in two parts, so that the sealing measures are also limited to these two components only. Thus, for fabrication, the first battery module can simply be inserted into the first module housing lower part, and then the module housing cover can be placed on the first module housing lower part and sealed with respect thereto. The same applies to the second module housing. In this way, any number of modules can be placed next to each other. As a result, a respective interior space is sealed not only from the other interior spaces of the battery arrangement, but also automatically from a remaining environment. This means that other vehicle components and, above all, the passenger compartment can also be efficiently protected from the gases escaping from a battery module in the event of a thermal runaway.

In another particularly advantageous embodiment of the invention, the first and second module housings are provided by a common battery housing comprising a housing lower part and a housing cover fitted to the housing lower part, the housing lower part providing the first and second module housing lower parts, wherein the first module cover is provided by a first portion of the housing cover, and the second module cover is provided by a second portion of the housing cover. This allows the battery arrangement to be implemented in a particularly simple and efficient manner, as it is not necessary to provide a separate module housing for each battery module. Advantageously, the individual battery modules can now also continue to be inserted into a common overall battery housing, which is simply referred to as the battery housing in this document, wherein, for example, chambers separated from one another can be provided by this battery housing. For example, the housing lower part can have several compartments separated from each other by partition walls, into which the individual battery modules are inserted. The sealed cover placed on the housing lower part thus also automatically seals these individual compartments against each other with regard to a possible gas exchange.

In another equally particularly advantageous embodiment of the invention, a battery housing is provided which comprises a housing lower part providing the first and second module housing lower parts, wherein the first and second module covers are formed separately from each other and are fitted onto the housing lower part. This design allows for further advantages due to a common housing lower part and individual, separate covers: the cover geometry of the individual module covers can be designed as a common part here, which would massively reduce the cost of the covers. Another aspect is the accessibility to individual modules for service without having to open the entire battery. Thus, all tests after opening a cover are limited to one battery module only.

Furthermore, it is advantageous if the individual module housings, which can be realized by an overall battery housing, are arranged next to each other with respect to a plane. This plane can be defined, for example, by a transverse vehicle axis and a longitudinal vehicle axis with respect to an intended arrangement of the battery arrangement in a motor vehicle. Preferably, then, the individual battery modules and their module housings are arranged side by side rather than stacked on top of each other. This has several advantages: on the one hand, this makes it possible to provide a particularly flat battery arrangement which, especially if it is designed as a high-voltage battery, can be integrated into a vehicle in a particularly space-efficient manner, for example in an underbody area of such a motor vehicle. On the other hand, the realization of the individual module housings can also be implemented in a particularly simple manner by means of an overall battery housing with a lower housing part and a housing cover. In addition, this can also provide a particularly simple decoupling of the direction in which a gas exits a battery cell and the direction in which adjacent battery modules are arranged. The at least one first and second battery cell preferably also have a releasable degassing opening, through which selective outgassing of a cell in the event of a thermal event is made possible. This is preferably located on an upper side of the relevant cell with respect to an intended installation position of the battery arrangement in a motor vehicle. This means that it is advantageous to ensure that the gas flow from a battery cell that is outgassing is directed upwards and thus not directly onto the module chamber arranged next to it. Seals between the housing cover and the housing lower part can thus withstand the temperatures much longer, as they are not directly exposed to the hot gas flow. This meets, for example, a central area of the cover part of the housing cover, which provides the relevant module cover of the relevant, thermally continuous battery module.

Now, to provide a seal between the relevant interior spaces from each other, there are several options. In an advantageous embodiment of the invention, a seal is arranged between the first module cover and the first module housing lower part along a closed contour, in particular on end faces of side walls that delimit the first interior space as part of the first module housing lower part. The same applies to the second module housing and any optional additional module housing. The end faces of the side walls are the sides facing the module housing cover. This is especially true when the module housings are provided by a common battery housing. In this case, the side walls may also be partition walls between two interior spaces in which the respective battery modules are located. Thus, a side wall can be part of the first module housing as well as part of the second module housing at the same time. Sealing the respective interior spaces against each other is now possible in a simple manner by simply arranging a seal on the end faces, preferably of all side walls, which surround and delimit a respective interior space, onto which the corresponding module cover or the overall housing cover is placed. The design of such a seal is also conceivable as a welded seam. Welding the module cover and the lower part of the module housing, for example, has the advantage of providing a particularly high degree of tightness. In this case, an additional seal is no longer required, since after welding there is a material bond between two components, which in turn brings a cost advantage. However, the use of a seal between the module cover and the lower part of the module housing other than a weld seam or weld has the great advantage that the cover can be removed more easily from the housing lower part again for maintenance and repair purposes, both at module level and at overall battery level. Therefore, this variant is also preferred.

In another advantageous embodiment of the invention, the seal constitutes a silicate seal and/or PTFE (polytetrafluoroethylene) seal and/or a high temperature seal. Such seals are also designed and suitable for very high temperature ranges, in particular, for example, for above 500° C. Thus, even in the event of a battery cell outgassing, a sufficiently good seal of the interior spaces against each other can be ensured permanently or at least temporarily. Such seals can, for example, be applied in viscous form as a closed contour on the end faces described above and then appropriate covers can be fitted. Subsequently, the seals harden and thus seal the respective interior spaces against each other.

In a further advantageous embodiment of the invention, the first and/or second module housing comprises at least one side wall in which a through opening is arranged through which at least one cable and/or electrical line is passed, wherein the cable and/or electrical line in the through opening is sealed with respect to the side wall. The cable may be, for example, an electrical cable used for interconnection purposes. Said side wall may in turn represent a partition or intermediate wall between two interior spaces, or it may also represent a side wall separating an interior space from an environment of the battery arrangement or the relevant module housing that is different from the other interior spaces. By sealing the cable or electrical line against the side wall, gas exchange in the event of a thermal event can also be prevented or at least largely prevented. This also makes it advantageously possible to run electrical cables or lines from interior space to interior space while still ensuring that the respective interior spaces are sealed off from one another. This simplifies the interconnection of the individual battery modules. However, it is also conceivable that the individual electrical cables for interconnecting the battery modules are not routed from interior space to interior space, but from a respective interior space of the battery modules to a common exterior, where they are then suitably interconnected. High temperature connectors can also be used to interconnect the individual battery modules. Corresponding contact points can also be provided on the partition walls between the respective interior spaces. The electrical cables of a battery module can then be contacted with these contact points. Depending on the desired interconnection, the contact points of adjacent battery modules can be electrically conductively connected to each other through the side wall concerned, for example by the electrical line mentioned above. So here, too, an additional seal can be made against the side wall.

In this context, it is further particularly advantageous if the at least one cable and/or the electrical line, e.g. the contact point, is sealed with respect to the side wall by means of a silicone-mica seal. Such seals are also particularly temperature-resistant and are therefore especially suitable for the application at hand.

In a further advantageous embodiment of the invention, a plurality of first battery cells are arranged in the first module housing, which are arranged next to one another in the form of a cell stack in a stacking direction, and which are formed in particular as prismatic battery cells. The same applies to the second module housing or any other optional module housing. In this way, the battery arrangement can be implemented in a particularly efficient and compact manner The fact that there are several battery cells per module housing means that the construction effort can be reduced enormously, especially in connection with the provision of a high-voltage battery. Since such a high-voltage battery usually has several battery modules anyway, efficient spatial decoupling can still be provided in the event of a thermal event and propagation of such a module. Even with only two battery modules, the separation described can already halve the danger and the extent of the damage.

Therefore, it is a further very advantageous embodiment of the invention if the battery arrangement is designed as a high-voltage battery. High-voltage batteries in particular have a very high energy content, especially when fully charged, which poses a very high potential risk, especially in the event of thermal propagation of a battery cell or a battery module. The measures described can reduce this potential danger to a fraction, and do so in a particularly simple and efficient manner

A motor vehicle having a battery arrangement according to the invention or one of its embodiments shall also be considered as belonging to the invention. The motor vehicle is preferably designed as an electric or hybrid vehicle.

Furthermore, the invention also relates to a method for providing a battery arrangement, wherein a first module housing having a first interior space and a second module housing having a second interior space are provided and at least one first battery cell is arranged in the first interior space and at least one second battery cell is arranged in the second interior space. Further, after arranging the first and second battery cells, the first and second interior spaces are sealed off from each other.

The advantages described for the battery arrangement according to the invention and its embodiments apply in the same way to the method according to the invention.

The invention also includes further embodiments of the method according to the invention which have features as already described in connection with the further embodiments of the battery arrangement according to the invention. For this reason, the corresponding further embodiments of the method according to the invention are not described again here.

The motor vehicle according to the invention is preferably designed as a motor vehicle, in particular as a passenger car or truck, or as a passenger bus or motorcycle.

The invention also includes combinations of the features of the described embodiments. Thus, the invention also includes implementations each having a combination of the features of more than one of the described embodiments, provided that the embodiments have not been described as mutually exclusive.

### BRIEF DESCRIPTION OF THE FIGURES

Examples of embodiments of the invention are described below. Showing for this purpose:

FIG. 1a schematic representation of the sequence of thermal propagation in a conventional battery according to an example not belonging to the invention;

FIG. 2a schematic representation of a battery arrangement according to an embodiment of the invention; and

FIG. 3a schematic representation of the sequence of a thermal propagation in a battery arrangement according to an embodiment of the invention.

### DETAILED DESCRIPTION

The embodiments explained below are preferred exemplary embodiments of the invention. In the exemplary embodiments, the described components of the embodiments each represent individual features of the invention that are to be considered independently of one another, and which also each independently further the invention. Therefore, the disclosure is intended to include combinations of the features of the embodiments other than those shown. Furthermore, the described embodiments can also be supplemented by further of the already described features of the invention.

In the figures, identical reference signs denote elements with identical functions.

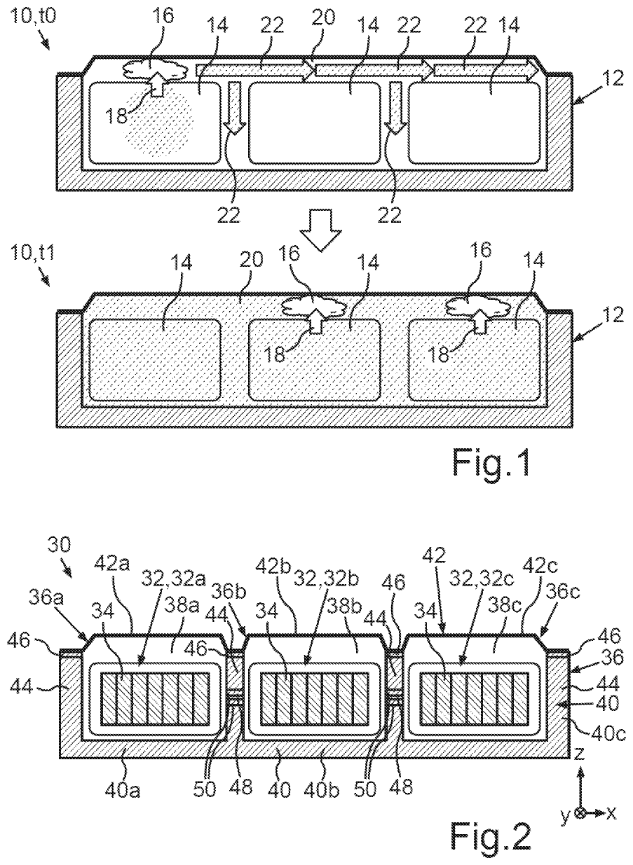

FIG. 1 shows a schematic representation of the sequence of a thermal propagation on a battery 10 according to an example not belonging to the invention. In this example, the battery 10 includes a battery housing 12 with battery modules 14 disposed therein. In FIG. 1, this battery 10 is shown firstly at an earlier first time t0, and below at a later second time t1. At the earlier first time t0, a first of the battery modules 14 begins to thermally propagate. In the course of such thermal propagation, the temperature in the cells of this battery module 14 rises and hot gas escapes from the cells. The outlet of this gas 16 is thereby illustrated by the arrow 18. In this case, the conventional battery housing 12 is constructed such that the cell modules 14 are located in a common interior space 20. Thus, air exchange can take place throughout the battery space 20. In the case of thermal propagation of a battery module 14, this causes the temperatures of the other battery modules 14 to also rise rapidly due to the propagating gas flow. The propagation of this gas flow is illustrated by arrows 22 in FIG. 1. As temperatures rise in the remaining battery modules 14, there is also thermal runaway of their battery cells and thermal propagation of the remaining battery modules 14, as illustrated in FIG. 1 below. Also, the electrically conductive precipitate due to the escaping gas stream 16 can distribute unhindered throughout the entire interior space 20, minimizing air and creepage distances, which additionally increases the risk of short circuits and leads to the increased formation of arcs and ultimately to the fire of the entire battery 10.

FIG. 2 shows a schematic representation of a battery arrangement 30 according to an embodiment of the invention. For example, the battery arrangement 30 may be a high voltage battery. In this regard, the battery arrangement 30 includes a plurality of battery modules 32, for example, a first battery module 32a, a second battery module 32b, and a third battery module 32c. Each of these battery modules 32 comprises at least one battery cell 34. In the present example, each of the battery modules 32 comprises a plurality of battery cells 34, although for clarity only one battery cell 34 per module 32 is given a reference number in FIG. 2. The battery cells 34 are preferably designed as prismatic battery cells, and can be arranged in the form of a cell stack next to each other, for example in the x-direction shown here. Instead, the individual battery cells 34 can also be arranged next to each other in the y-direction. Furthermore, the individual battery modules 32 are also arranged next to each other in the x-direction here as an example. Alternatively or additionally, the battery modules 32 may be arranged side by side in the y-direction. The z-axis shown here preferably corresponds to a vehicle vertical axis with respect to an intended installation position of the battery arrangement 30 in a motor vehicle. In principle, however, it is also conceivable that battery modules 32 are arranged one above the other with respect to the z-direction, although this is less preferred.

The battery modules 32 are now further arranged in a common battery housing 36. However, unlike conventional battery housings, this battery housing 36 now provides a separate chamber 38a, 38b, 38c for a respective battery module 32. This provides a separate module housing 36a, 36b, 36c, so to speak, for each battery module 32. Wherein said chambers 38a, 38b, 38c then correspondingly define respective interior spaces 38a, 38b, 38c of respective module housings 36a, 36b, 36c. These respective interior spaces 38a, 38b, 38c are now advantageously sealed from each other. Thus, in the event of a thermal event, a buildup of the reaction can be prevented and propagation of a thermal propagation can be limited to a single module 32. As soon as, for example, all cells 34 of the affected module 32 are propagated, the reaction comes to a standstill, since it is then no longer possible to spread to adjacent modules 32. In order to implement such a seal in the simplest and most efficient manner, the battery housing 36 preferably includes a housing lower part 40 and a cover 42. The housing lower part 40 provides respective module housing lower parts 40a, 40b, 40c, and the housing cover 42 provides respective module covers 42a, 42b, 42c. Accordingly, the housing lower part 40 also has side walls 44 that separate the individual chambers 38a, 38b, 38c from each other and from the environment. In this regard, some of the side walls 44 are simultaneously part of two module housing lower sections 40a, 40b, 40c and, so to speak, simultaneously act as partition walls between the chambers 38a, 38b, 38c. A seal 46 can be arranged on the end faces of the respective side walls 44 between the cover 42 and the housing lower part 40 to seal the interior spaces 38a, 38b, 38c from one another. This is preferably designed as a silicate seal and/or PTFE seal and/or as a high-temperature seal. Such a seal 46 thus seals the housing cover 42 from the housing lower part 40 in the region of respective side walls 44 and thus also seals the respective interior spaces 38a, 38b, 38c from one another.

Optionally, electrical lines 48 in side walls 44 may also be sealed from the side walls 44 via a corresponding seal 50. Such electrical lines 48, or contacting regions 48 in general, may be used to interconnect the battery modules 32. Thus, such contacting regions 48 in the sidewalls 44 can also be designed to be sealed, again minimizing the likelihood of gas leakage should one of the modules 32 thermally propagate.

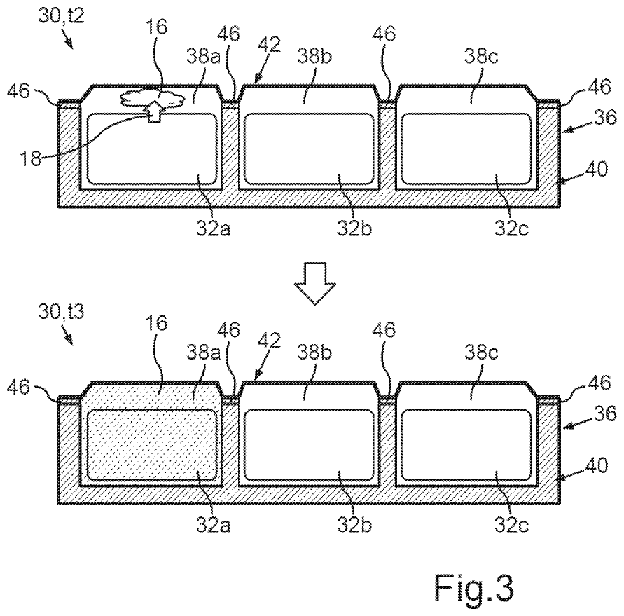

Thus, the high voltage battery system provided by the battery arrangement 30 may be constructed with individual chambers 38a, 38b, 38c for the individual battery modules 32a, 32b, 32c and cell modules, respectively. The housing 36 is preferably made of a metallic material. The appropriate shaping of the cover 42, which is preferably made of steel, separates the chambers 38a, 38b, 38c from each other in an airtight or at least nearly airtight manner A corresponding temperature-stable seal, for example one of those mentioned above, is very advantageous here. If a thermal event of a cell 34 now occurs, the propagation can be reduced to only one cell module 32, as illustrated in FIG. 3. FIG. 3 illustrates once again the battery arrangement 30 described for FIG. 2 at a first earlier time t2 and at a later second time t3. At the first earlier time t2, thermal propagation of the first battery module 32a occurs. Concomitantly, there is an outflow 18 of gases 16 from the first battery module 32a. This gas leakage may initially affect only one of the battery cells 34 of the first battery module 32a, and may spread throughout all of the battery cells 34 of the first battery module 32a. In the course of such thermal propagation, there is also a tremendous temperature rise within the first battery module 32a and, after gas leakage, also within the first interior space 38a. However, the escaping gas cannot enter the other chambers 38b, 38c. Spreading of thermal propagation to the other battery modules 32b, 32c can thus be prevented. Thus, at the later second time t3, only the first battery module 32a has propagated, while the temperatures of the other battery modules 32b, 32c have remained essentially the same or at least have increased little or only slightly compared to the first time t2. Thermal propagation of these remaining battery modules 32b, 32c can thus be prevented, and propagation of the electrically conductive precipitate into the remaining chambers 38b, 38c can thus also be prevented. In addition, a fire of the module 32a cannot spread to the other chambers 38b, 38c.

Overall, the examples show how the invention can provide a chamber battery that makes it possible in a simple and efficient manner to limit thermal propagation to battery cells concerned in the event of a thermal event within a battery module. This can significantly increase safety, especially in connection with high-voltage batteries.

1. A battery arrangement for a motor vehicle, comprising a first battery module including at least one first battery cell and a second battery module including at least one second battery cell, wherein the first battery module includes a first module housing with a first interior space in which the at least one first battery cell is arranged, and the second battery module includes a second module housing with a second interior space in which the at least one second battery cell is arranged, wherein the first and second interior spaces are sealed with respect to one another.

2. The battery arrangement according to claim 1, wherein the first module housing includes a first module housing lower part and a first module cover which is placed on the first module housing lower part and is sealed with respect to the first module housing lower part and wherein the second module housing includes a second module housing lower part and a second module cover which is placed on the second module housing lower part and is sealed with respect to the second module housing lower part.

3. The battery arrangement according to claim 2, wherein the first and second module housings are provided by a common battery housing including a housing lower part and a housing cover which is placed on the housing lower part, wherein the housing lower part provides the first and second module housing lower parts, wherein the first module cover is provided by a first portion of the housing cover and the second module cover is provided by a second portion of the housing cover.

4. The battery arrangement according to claim 2, wherein a seal is arranged between the first module cover and the first module housing lower part along a closed contour, on end faces of side walls which, as part of the first module housing lower part, delimit the first interior space.

5. The battery arrangement according to claim 4, wherein the seal is a silicate seal and/or PTFE (polytetrafluoroethylene) seal and/or a high-temperature seal.

6. The battery arrangement according to claim 1, wherein the first and/or second module housing includes at least one side wall in which a through opening is arranged through which at least one cable and/or an electrical line is passed, wherein the cable and/or the electrical line is sealed in the through opening with respect to the side wall.

7. The battery arrangement according to claim 6, wherein the at least one cable and/or an electrical line is sealed with respect to the side wall by means of a silicone-mica seal.

8. The battery arrangement according to claim 1, wherein a plurality of first battery cells are arranged in the first module housing, which are arranged next to one another in the form of a cell stack in a stacking direction, and which are formed as prismatic battery cells.

9. The battery arrangement according to claim 1, wherein the battery arrangement is a high-voltage battery.

10. A method for providing a battery arrangement, comprising the steps of:
providing a first module housing with a first interior space and a second module housing with a second interior space; and
arranging at least one first battery cell in the first interior space and at least one second battery cell in the second interior space; and
sealing the first and second interior spaces to each other after arranging the at least one first and second battery cells.

11. The battery arrangement according to claim 3, wherein a seal is arranged between the first module cover and the first module housing lower part along a closed contour, on end faces of side walls which, as part of the first module housing lower part, delimit the first interior space.

12. The battery arrangement according to claim 2, wherein the first and/or second module housing includes at least one side wall in which a through opening is arranged through which at least one cable and/or an electrical line is passed, wherein the cable and/or the electrical line is sealed in the through opening with respect to the side wall.

13. The battery arrangement according to claim 3, wherein the first and/or second module housing includes at least one side wall in which a through opening is arranged through which at least one cable and/or an electrical line is passed, wherein the cable and/or the electrical line is sealed in the through opening with respect to the side wall.

14. The battery arrangement according to claim 4, wherein the first and/or second module housing includes at least one side wall in which a through opening is arranged through which at least one cable and/or an electrical line is passed, wherein the cable and/or the electrical line is sealed in the through opening with respect to the side wall.

15. The battery arrangement according to claim 5, wherein the first and/or second module housing includes at least one side wall in which a through opening is arranged through which at least one cable and/or an electrical line is passed, wherein the cable and/or the electrical line is sealed in the through opening with respect to the side wall.

16. The battery arrangement according to claim 2, wherein a plurality of first battery cells are arranged in the first module housing, which are arranged next to one another in the form of a cell stack in a stacking direction, and which are formed as prismatic battery cells.

17. The battery arrangement according to claim 3, wherein a plurality of first battery cells are arranged in the first module housing which are arranged next to one another in the form of a cell stack in a stacking direction, and which are formed as prismatic battery cells.

18. The battery arrangement according to claim 4, wherein a plurality of first battery cells are arranged in the first module housing, which are arranged next to one another in the form of a cell stack in a stacking direction, and which are formed as prismatic battery cells.

19. The battery arrangement according to claim 5, wherein a plurality of first battery cells are arranged in the first module housing, which are arranged next to one another in the form of a cell stack in a stacking direction, and which are formed as prismatic battery cells.

20. The battery arrangement according to claim 6, wherein a plurality of first battery cells are arranged in the first module housing, which are arranged next to one another in the form of a cell stack in a stacking direction, and which are formed as prismatic battery cells.
